(19) United States
(12) Patent Application Publication
(10) Pub. No.: US 2016/0259821 A1
(43) Pub. Date: Sep. 8, 2016

(54) EFFICIENT STORAGE AND SEARCHING OF OBJECT STATE AND RELATIONSHIPS AT A GIVEN POINT OF TIME

(71) Applicant: GENERAL ELECTRIC COMPANY, Schenectady, NY (US)

(72) Inventors: Bharath Rao, Pleasanton, CA (US); Nirmal Kumar Ramyagya Gupta, Sunnyvale, CA (US)

(21) Appl. No.: 14/638,845

(22) Filed: Mar. 4, 2015

(51) Int. Cl. G06F 17/30; H04L 29/06

(52) U.S. Cl. CPC G06F 17/30368; H04L 67/42; G06F 17/30477

(57) ABSTRACT

A system and method for efficient storage and searching of object state data and relationships at a given point of time is disclosed. A server system stores one or more data objects in a database associated with a server system. The server system receives an update to one or more data objects stored in the database. For a respective object, the server system determines one or more differences between the respective original data object and the respective updated data object, creates a change entry for the respective data object, and stores the created change entry in a change database at the server system. The server system receives a data query and searches the one or more change entries stored in the change database to identify the information associated with the received search query. The server system sends the identified information to the client system.

### TECHNICAL FIELD

The disclosed example embodiments relate generally to the field of electronic devices and, in particular, to efficient data storage and retrieval in server systems.

### BACKGROUND

The rise of the computer age has resulted in increased access to personalized services online. As the cost of electronics and networks drop, many services that were previously provided in person are now provided remotely over the Internet. For example, entertainment has increasingly shifted to the online space with companies streaming television (TV) shows and movies to members at home. Similarly, electronic mail (e-mail) has reduced the need for letters to be physically delivered. Instead, messages can be sent over networked systems almost instantly. Online social networking sites allow members to build and maintain personal and business relationships in a much more comprehensive and manageable manner.

As more and more services are provided online, large amounts of data are generated consistently. Much of this data needs to be saved for later use. For example, messages, search histories, browsing histories, and statistical analyses of data need to be saved to be useful in the future. With so much data needing to be saved, storage systems need to be able to accommodate a large amount of data reliably. Additionally, for the information to be useful, the data needs to be reasonably accessible to queries about the contents and/or state of the data. In particular, it is useful to be able to efficiently search for past states and determine how specific data has changed over time.

### DESCRIPTION OF THE DRAWINGS

Some example embodiments are illustrated by way of example and not limitation in the FIGS. of the accompanying drawings, in which:

FIG. 1 is a network diagram depicting a server system, in accordance with an example embodiment, that includes various functional components.

FIG. 2 is a block diagram illustrating a client system, in accordance with some example embodiments.

FIG. 3 is a block diagram further illustrating the server system, in accordance with some example embodiments.

FIG. 4 is a block diagram of an example data structure, in accordance with some example embodiments, for the update data in accordance with some example embodiments.

FIG. 5 is an example embodiment of text representations of the various steps in generating a text representation of an update, in accordance with an example embodiment.

FIG. 6 is a flow diagram illustrating a method, in accordance with an example embodiment, for efficient storage and searching of object state and relationships at a given point of time.

FIG. 7 is a flow diagram illustrating another method, in accordance with an example embodiment, for efficient storage and searching of object state and relationships at a given point of time.

FIG. 8 is a block diagram illustrating an architecture of software, in accordance with an example embodiment, which may be installed on any one or more devices.

FIG. 9 is a block diagram illustrating components of a machine, in accordance with an example embodiment.

Like reference numerals refer to corresponding parts throughout the drawings.

### DETAILED DESCRIPTION

The present disclosure describes methods, systems, and computer program products for efficient storage and searching of object state and relationships at a given point in time. In the following description, for purposes of explanation, numerous specific details are set forth to provide a thorough understanding of the various aspects of different embodiments. It will be evident, however, to one skilled in the art, that any particular embodiment may be practiced without all of the specific details and/or with variations permutations and combinations of the various features and elements described herein.

When storing a large amount of data, databases typically use a specialized object format. When an update is received into the database, a record of the update is stored in a changelog. Thus, to recreate a past state, the database needs to run through the entire past changelog to the desired state. Depending on the size of the data set to be reconstructed, this can be prohibitively time-consuming and resource draining. Specifically, if queries are received that reference past states of the data, it is difficult to respond to said queries in a timely manner.

In some example embodiments, when an update to a respective data object stored in a data system (or a new data object) is received, the server system compares the newly received update to the current version of the object (e.g., the state of the respective data object prior to the update) to determine a set of differences. Once the set of differences is determined, the differences can be stored as a text based entry in a table of changes. Each change will identify the respective data object's identifier, the updated elements (with both the original and updated values), the time of the update, and any other relevant data. In some example embodiments, each entry in the table of changes is formatted in JavaScript Object Notation (JSON). In other example embodiments, each entry is a string.

In some example embodiments, the server system receives a query for a client system 102. The query is a request for information about a past state of the data stored at the server system. For example, the query identifies a particular object with a request to know when that object was last updated. In an old system, the server system would have to rebuild the database from scratch, noting each instance when the particular object was updated. Only once the database was completely rebuilt (an enormously complicated task) could the server system definitively know the most recent update to the particular object

In contrast, when the changes are stored in a text format, the server system can use modern text search techniques to identify each entry that included an update to the particular object. Once the list of entries is identified, the server system simply chooses the entry with the most recent timestamp and uses it to reconstruct the data state for that object at the appropriate time.

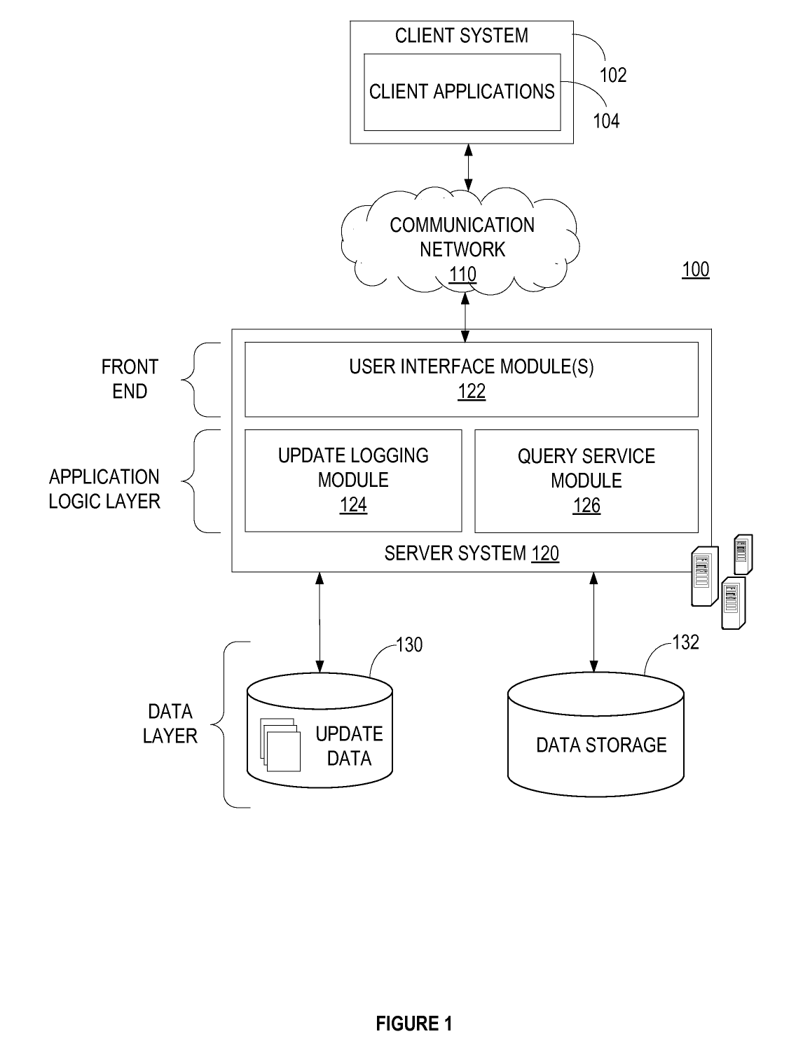

FIG. 1 is a network diagram depicting a client-server environment 100, in accordance with an example embodiment, that includes various functional components. In some example embodiments, client-server environment 100 includes a client system 102 and a server system 120. One or more communications networks 110 interconnect these components. The communications network 110 may be any of a variety of network types, including local area networks (LANs), wide area networks (WANs), wireless networks, wired networks, the Internet, personal area networks (PANs), or a combination of such networks.

The client system 102 includes one or more client applications 104, which are executed by the client system 102. In some example embodiments, the client application(s) 104 includes one or more applications from the set consisting of search applications, communication applications, productivity applications, game applications, word processing applications, or any other useful applications. The client system 102 communicates with the server system 120 to request information about data stored at the server system 120 using one or more search queries.

In some example embodiments, in response to the query, the client system 102 receives data sought by the query from the server system 120.

In some example embodiments, as shown in FIG. 1, the server system 120 is generally based on a three-tiered architecture, consisting of a front-end layer, an application logic layer, and a data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various embodiments have been omitted from FIG. 1. However, a skilled artisan will readily recognize that various additional functional modules and engines may be used with a server system 120, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although the server system 120 is depicted in FIG. 1 as having a three-tiered architecture, the various embodiments are by no means limited to this architecture.

As shown in FIG. 1, the front-end layer consists of a user interface module (e.g., a touch screen) 122, which receives input from a user through one or more input systems (e.g., keyboard, mouse, touch screen, microphone), and presents the appropriate responses on one or more output systems (e.g., screen, speakers, and so on).

As shown in FIG. 1, the data layer includes one or more databases, including databases for storing data for users of the server system 120, including update data 130 and data storage 132.

In some example embodiments, the data storage 132 is a database (or other data structure) for storing one or more data objects associated with the server system 120. Depending on the specific function of the server system 120, the data storage 132 database can include data objects for a variety of potential uses.

In some example embodiments, the update data 130 is a series of entries that each document (or represent) a specific update to the data objects in the data storage 132. Each entry includes the identity of the updated object, the specific entries that were updated (including the original and updated values for these entries), the time of the update, and any other relevant data. These entries are stored in an easily searchable text format, such as JSON.

In some example embodiments, the server system 120 provides a broad range of other applications and services that are useful one or more users.

In some example embodiments, the application logic layer includes various application server modules, which, in conjunction with the user interface module(s) 122, generate various user interfaces to receive input from and deliver output to a user. In some example embodiments, individual application modules are used to implement the functionality associated with various applications, services, and features of the server system 120. For instance, a messaging application, such as an email application, an instant messaging application, or some hybrid or variation of the two, may be implemented with one or more application modules.

In addition to the various application server modules, the application logic layer includes an update logging module 124 and a query service module 126. As illustrated in FIG. 1, in some example embodiments, the update logging module 124 and the query service module 126 are implemented as modules that operate in conjunction with various application modules. For instance, any number of individual application modules can invoke the functionality of the update logging module 124 and the query service module 126 to store updates and process queries. However, in various alternative embodiments, the update logging module 124 and the query service module 126 may be implemented as their own application modules such that they operate as a stand-alone application.

Generally, the update logging module 124 receives update data that needs to be stored on the server system 120. In some example embodiments, the updates are generated internally to the server system 120 as the server system 120 processes data. In other example embodiments, the updates are received from client systems 102 via a network 110. In some example embodiments, the update logging module 124 uses the update data to identify the one or more data objects being updated by the update data 130.

In some example embodiments, once the one or more objects have been identified, the update logging module 124 compares the un-updated version of each data object to the updated version indicated by the update data 130 and creates a list of differences. For example, in some example embodiments, each data object includes one or more entries (or data keys) that have an associated value. For example, if each data object represents a car in a taxi service, each object includes the entries “Position”, “Speed”, and “Availability.” The update logging module 124 receives an update to set the “availability” for a particular car (e.g., Car A) to “false.” The update logging module 124 determines that the previous value for the key entry “availability” was true (e.g., indicating that the car had no current passenger and was available for fares). The update logging module 124 determines the list of changes includes CarA.availability: True=>False.

In some example embodiments, the update logging module 124 then stores the list of differences (e.g., the updates to the specific data object) in the update data 130 in a text-based representation. In some example embodiments, the update logging module 124 uses a JSON format to store the data. In other example embodiments, the difference data entry is stored as a simple string. Each entry in the update data 130 includes an identifier for the specific data object, the entry (or key) being changed, the old value associated with the key, the new value associated with the key, the date/time information that the update was accomplished, and so on.

In some example embodiments, the update data 130 stored this way is then ready for easy searching.

The query service module 126 receives queries from one or more client systems 102. Each received query includes a specific request for information. The query service module 126 first converts the query into a format that can be used to search the update data 130. For example, the query service module 126 extracts relevant query data, such as the data object in question, the date of interest, one or more data key, and any associated values.

In some example embodiments, the query service module 126 uses the converted query to search the update data 130 quickly and efficiently. Once the requested data has been identified, the query service module 126 returns the identified data to the requesting client system 102.

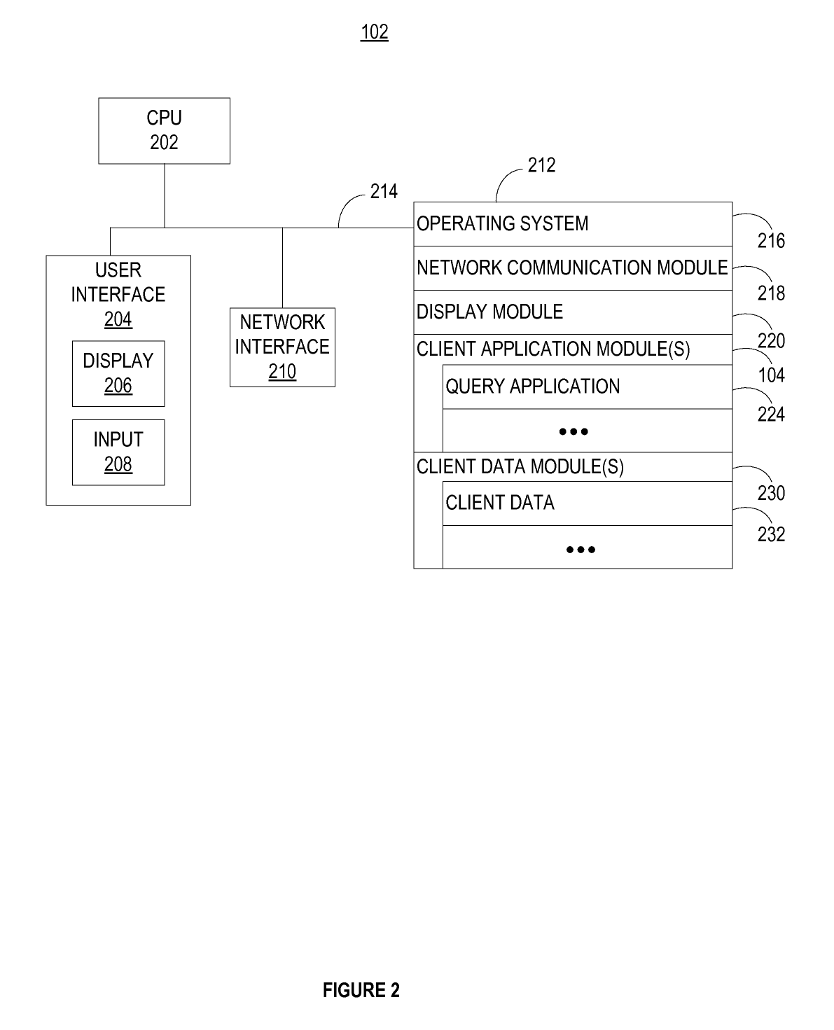

FIG. 2 is a block diagram illustrating a client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer readable storage medium.

In some example embodiments, memory 212 or the computer-readable storage medium of memory 212 stores the following programs, modules, and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks 110, such as the Internet, other WANs, LANs, metropolitan area networks (MANs), etc.;
a display module 220 for enabling the information generated by the operating system 216 and client applications 104 to be presented visually on the display 206;
one or more client applications 104 for handling various aspects of interacting with the server system 120 (FIG. 1), including but not limited to:
   a query application 224 for sending queries to the server system (e.g., server system 120 in FIG. 1) and receiving responses from the server system 120; and
a client data module(s) 230, for storing data relevant to the clients, including but not limited to:
   client data 232 for storing data related to the client system 102, including but not limited to data received from the server system (e.g., server system 120 in FIG. 1) as a response to a query.

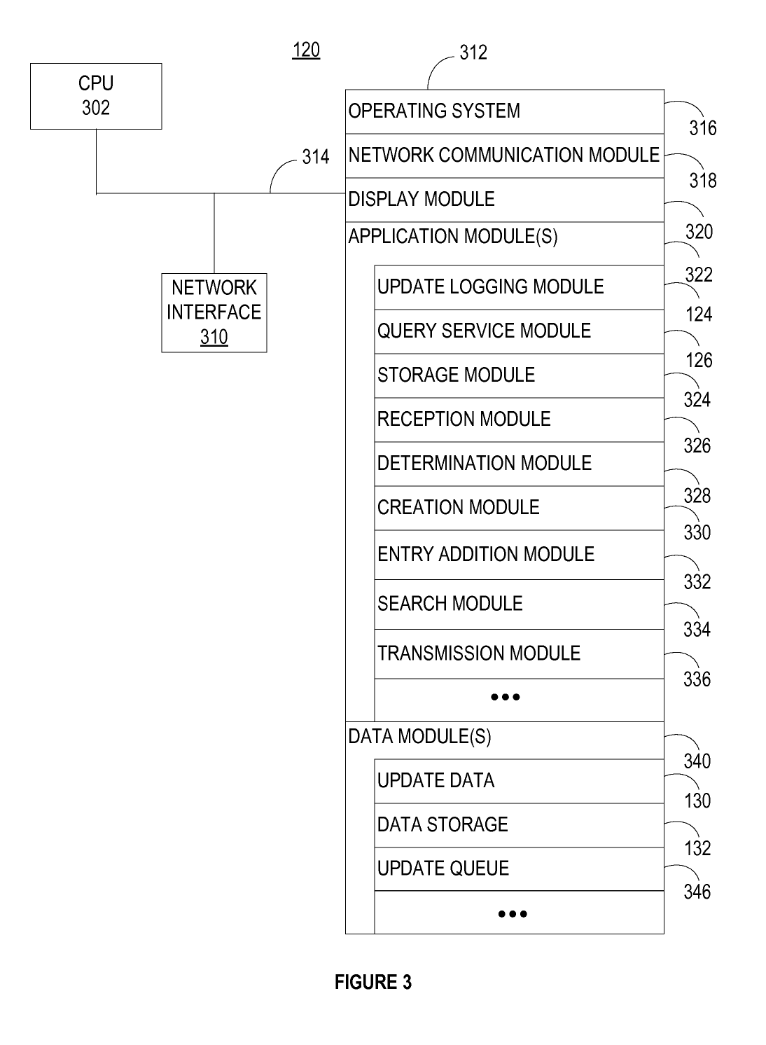

FIG. 3 is a block diagram further illustrating the server system 120, in accordance with some example embodiments. The server system 120 typically includes one or more CPUs 302, one or more network interfaces 310, memory 312, and one or more communication buses 314 for interconnecting these components. Memory 312 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 312 may optionally include one or more storage devices remotely located from the CPU(s) 302.

Memory 312, or alternately the non-volatile memory device(s) within memory 312, comprises a non-transitory computer readable storage medium. In some example embodiments, memory 312, or the computer readable storage medium of memory 312, stores the following programs, modules, and data structures, or a subset thereof:
an operating system 316 that includes procedures for handling various basic system services and for performing hardware dependent tasks;
a network communication module 318 that is used for connecting the server system 120 to other computers via the one or more communication network interfaces 310 (wired or wireless) and one or more communication networks 110, such as the Internet, other WANs, LANs, MANs, and so on;
one or more server application modules 322 for performing the services offered by server system 120, including but not limited to:
   an update logging module 124 for receiving updates to data stored in the data storage 132, convert the updates into a text based form, and store the text based update representations in the update data 130;
   a query service module 126 for receiving queries from a client system (e.g., system 102 in FIG. 1), converting them into a form useable by the server system 120, executing the query to retrieve the requested information, and returning the requested information to the client system (e.g., system 102 in FIG. 1);
   a storage module 324 for storing data associated with the server system 120 in the data storage 132;
   a reception module 326 for receiving updates to the data stored in the data storage 132;
   a determination module 328 for determining differences between an original data object and an updated data object;
   a creation module 330 for creating an entry in the update data 130 based on the determined differences between an original data object and an updated data object which has received updates;
   an entry addition module 332 for adding an entry to the update data 130 that was created by the creation module 330;
   a search module 334 for conducting searches based on search queries received from client systems (e.g., system 102 in FIG. 1); and
   a transmission module 336 for transmitting search results to the requesting client system (e.g., system 102 in FIG. 1); and
server data module(s) 340, holding data related to server system 120 , including but not limited to:
   update data 130 including data entries representing the differences caused by each update to the data objects stored in the data storage 132;
   data storage 132 includes one or more data objects, each data object including one or more elements, each element representing a key-value pair;
   an update queue 346 including a list of updates to be applied to the data storage 132.

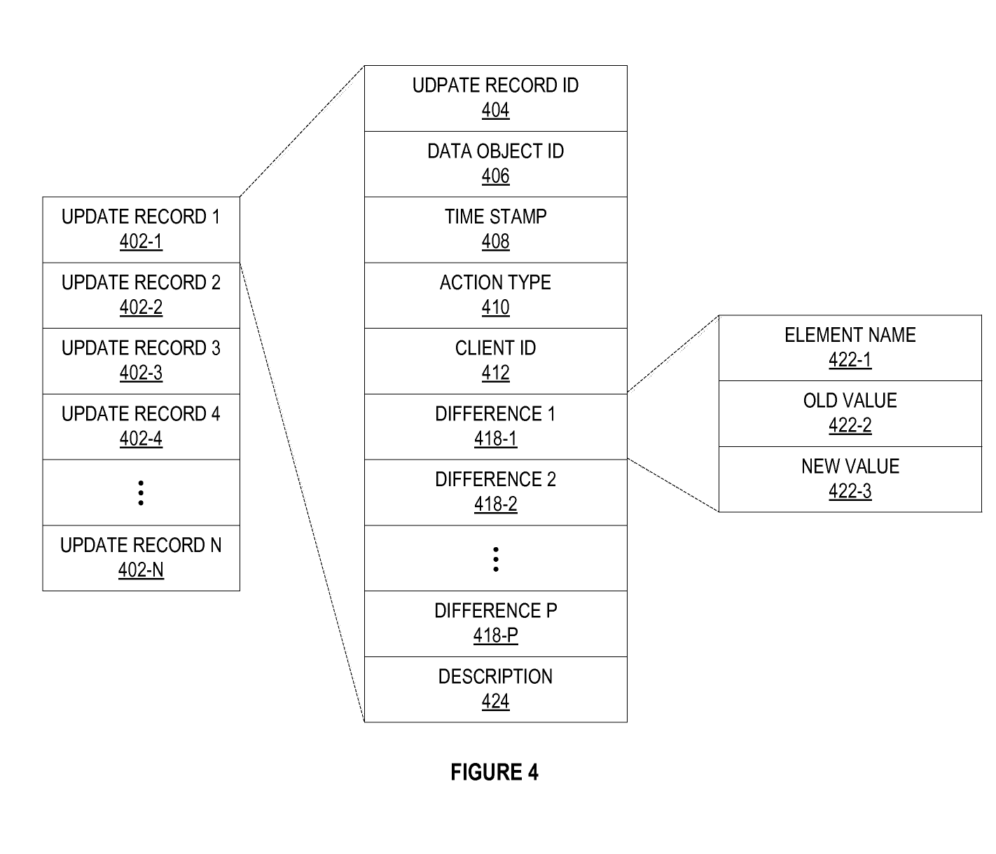

FIG. 4 depicts a block diagram of an example data structure, in accordance with some example embodiments, for the update data 130, in accordance with some example embodiments. In accordance with some example embodiments, the update data 130 data structure includes a plurality of update records 402-1 to 402-N, each of which corresponds to a update received by the server system (e.g., server system 120 in FIG. 1) and created by the update logging module (e.g., module 124 in FIG. 1). For example, the server system (e.g., server system 120 in FIG. 1) receives an update from a client system (e.g., system 102 in FIG. 1). The update logging module 124 uses the update data 130 to identify one or more differences caused by the update. The update logging module 124 then stores the update as an update record 402 in the update data 130. Each update record 402-1 to 402-N stores all the relevant information for each update, such that the entire data set can be reconstructed based only on the update data 130 if need be.

In some example embodiments, a respective update record 402 stores a update record ID 404, a data object ID 406, a time stamp 408, an action type 410, a client ID 412, one or more difference records 418-1 to 418-P, and a description 424 (included to describe the reason for the update, if needed).

In some example embodiments, the update record ID 404 is a unique identifier for the current update record 402. In some example embodiments, the data object ID 406 is a unique identifier for the data object that is being updated. In some example embodiments, the time stamp 408 is a record of the precise time and date that the update was executed (or in some cases received by the server system (e.g., server system 120 in FIG. 1)).

In some example embodiments, the action type 410 describes the type of update. For example, when a new data object or element is added, the action type 410 is “added.” Similarly, when a data object is removed the action type 410 is “removed” or “deleted”. Other action types are used as appropriate. In some example embodiments, the client ID 412 is an identifier unique to the client who sent or caused the update. Thus, all updates can be traced to their source.

In some example embodiments, the one or more difference records 418-1 to 418-P represent each noted difference. Each difference record 418 includes at least the element name 422-1, an old value for the element 422-2, and a new value 422-3 for the element.

In some example embodiments, the description 424 includes optional information describing why an update was done, including whether it was part of a larger update plan, whether it is related to any other updates, and any other important information.

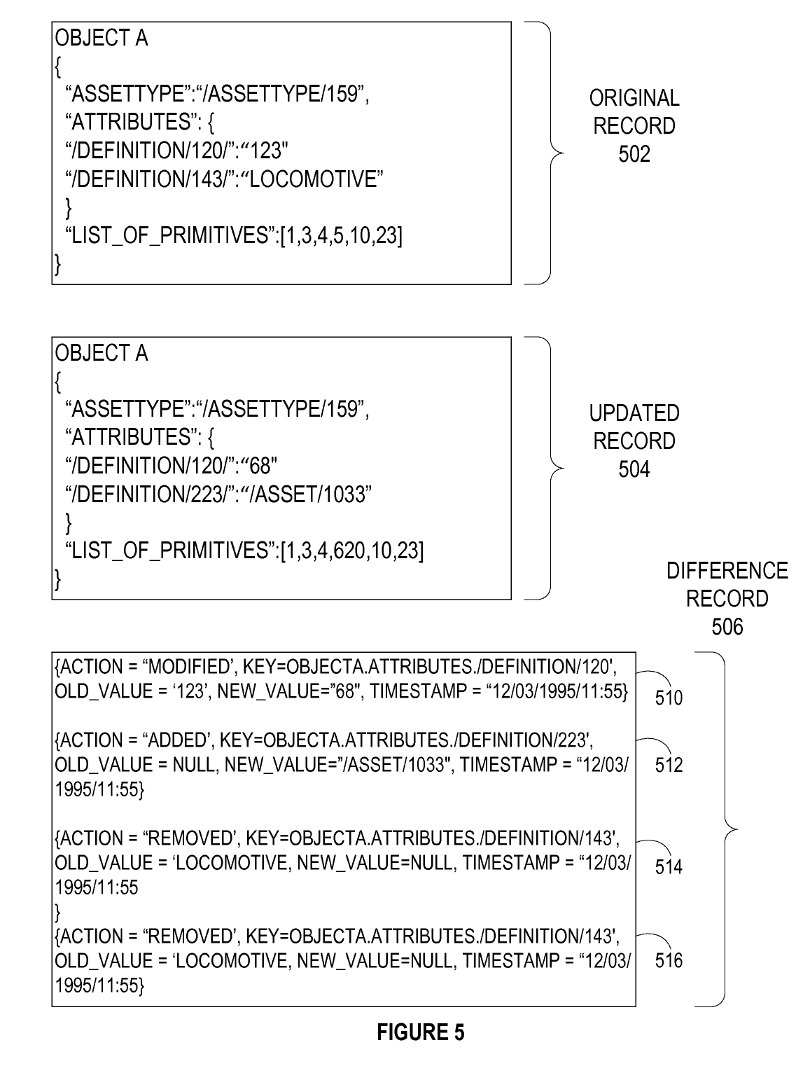

FIG. 5 is an example embodiment of a text representation of the various steps in generating a text representation of an update, in accordance with an example embodiment. The update process begins with an original record 502. The original record 502 is for a data object (Object A) and includes a series of elements (Assettype, a list of attributes, and a list of primitives) each with a corresponding value.

In some example embodiments, the server system (e.g., server system 120 in FIG. 1) receives an updated record 504. The updated object also represents object A. The list of elements has been updated, with some elements being removed, others added, and some with associated values that have been changed.

In some example embodiments, once the updated record 504 has been received, the server system (e.g., server system 120 in FIG. 1) compares the original record 502 to the updated record 504.

In some example embodiments, the server system (e.g., server system 120 in FIG. 1) then produces a difference record 506. In some example embodiments, a difference record 506 includes a plurality of entries, each entry representing a difference between the original record 502 and the updated record 504.

The example difference record 506 shown in FIG. 5 has four difference entries (510, 512, 514, and 516). Each record has a record of the action (e.g., 510 has an action of “Modified”), the key (e.g., the name of the updated element), the old value associated with the key, the new value associated with the key, and the timestamp of the update.

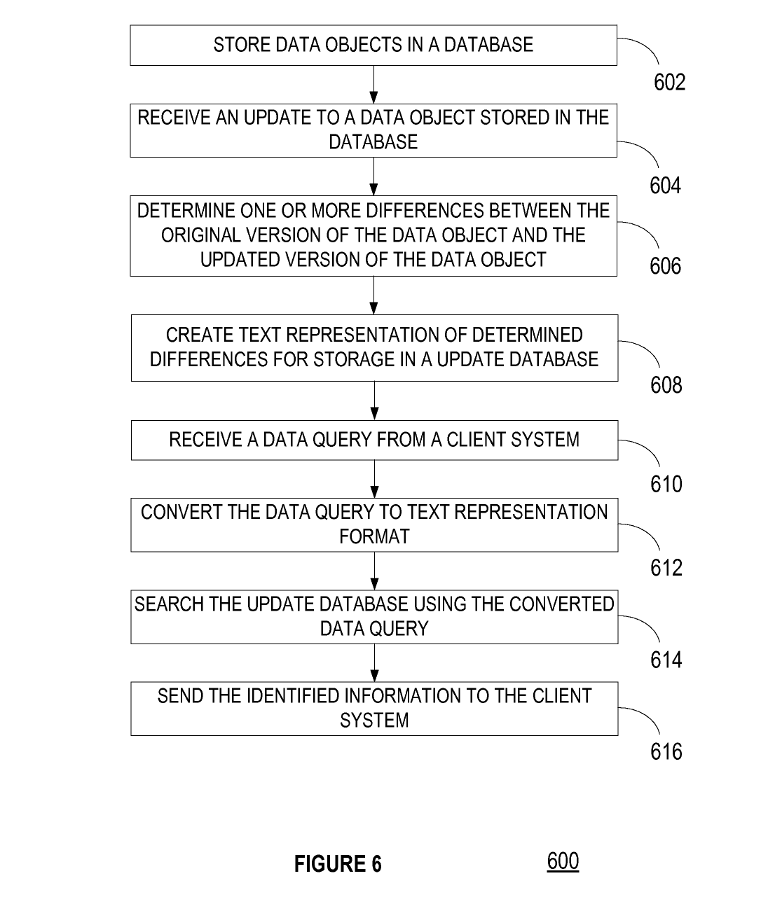

FIG. 6 is a flow diagram illustrating a method 600, in accordance with an example embodiment, for efficient storage and searching of object state and relationships at a given point of time. Each of the operations shown in FIG. 6 may correspond to instructions stored in a computer memory 312 or computer readable storage medium. In some example embodiments, the method 600 described in FIG. 6 is performed by the server system (e.g., the server system 120 in FIG. 1).

In some example embodiments, the method 600 is performed at a server system (e.g., the server system 120 in FIG. 1) including one or more processors and memory 312 storing one or more programs for execution by the one or more processors.

In some example embodiments, the server system (e.g., the server system 120 in FIG. 1) stores (602) one or more data objects in a database associated with the server system (e.g., server system 120 in FIG. 1). Each data object includes one or more elements. Each element includes a key value pair for storing data associated with the data object.

In some example embodiments, the server system (e.g., server system 120 in FIG. 1) receives (604) an update to a data object stored in the database associated with the server system (e.g., server system 120 in FIG. 1). In some example embodiments, the update is received from a client system (e.g., system 102 in FIG. 1). In some example embodiments, the update is generated by a component of the server system (e.g., server system 120 in FIG. 1) and transmitted to an update logging module 124 for storage.

In some example embodiments, the server system (e.g., server system 120 in FIG. 1) determines (606) one or more differences between the original version of the data object and the updated version of the data object. For example, the server system (e.g., server system 120 in FIG. 1) analyzes each element of the updated data object to determine if the value has changed. In some example embodiments, the server system (e.g., server system 120 in FIG. 1) also determines if any elements have been added or removed.

In some example embodiments, the server system (e.g., server system 120 in FIG. 1) creates (608) a text representation of determined differences between an original data object and an updated data object to be stored in an update database. For example, the differences are stored in a single string that stores the identifier of the data object being updated, the element in question, the original value of the element, the updated value of the element, and a timestamp of the update.

In some example embodiments, the server system (e.g., server system 120 in FIG. 1) receives (610) a data query from a client system (e.g., system 102 in FIG. 1). In some example embodiments, the server system (e.g., server system 120 in FIG. 1) converts (612) the data query to text representation format.

In some example embodiments, the server system (e.g., server system 120 in FIG. 1) then uses the converted data query to search (614) the update database 130 for the information requested by the received search query. In some example embodiments, the server system (e.g., server system 120 in FIG. 1) then sends (616) the identified information to the client system (e.g., system 102 in FIG. 1).

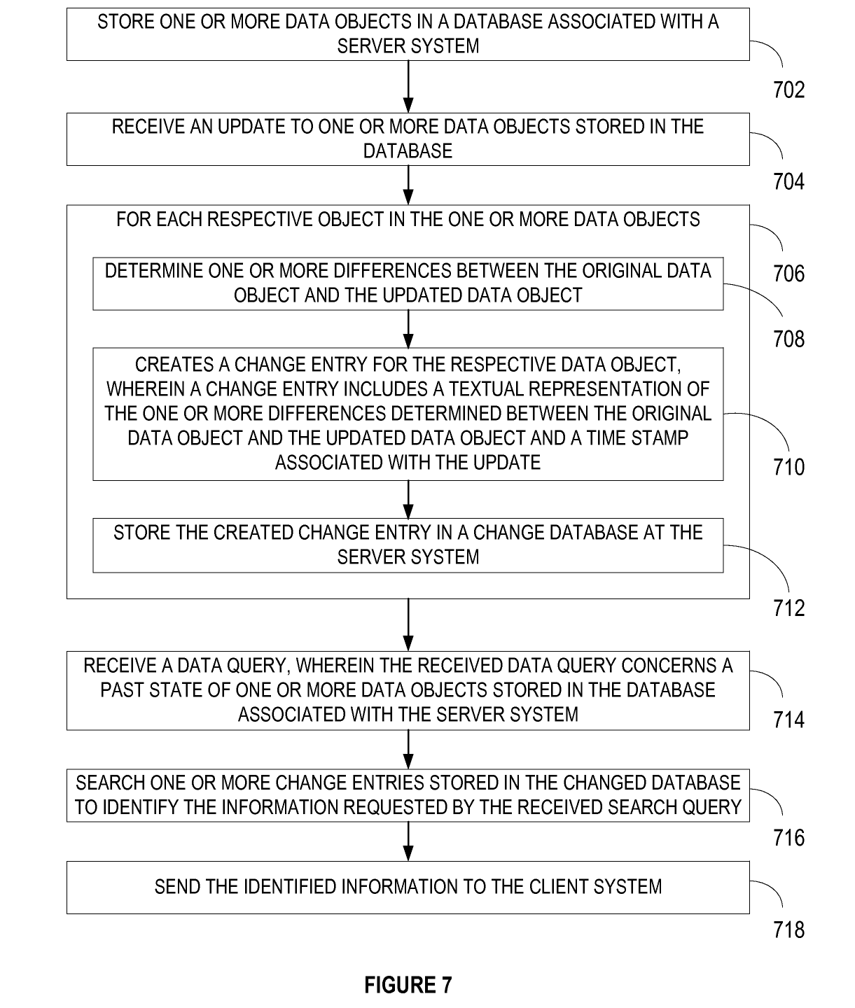

FIG. 7 is a flow diagram illustrating another method, in accordance with an example embodiment, for efficient storage and searching of object state and relationships at a given point of time. Each of the operations shown in FIG. 7A may correspond to instructions stored in a computer memory 312 or computer readable storage medium. Optional operations are indicated by dashed lines (e.g., boxes with dashed-line borders). In some example embodiments, the method described in FIG. 7A is performed by the server system (e.g., the server system 120 in FIG. 1). However, the method described can also be performed by any other suitable configuration of electronic hardware.

In some example embodiments, the method is performed at a server system (e.g., the server system 120 in FIG. 1) including one or more processors and memory 312 storing one or more programs for execution by the one or more processors.

In some example embodiments, the server system (e.g., server system 120 in FIG. 1) stores (702) one or more data objects in a database associated with a server system 120. In some example embodiments, the data objects can represent any number of different types of data. In some example embodiments, each data object includes one or more elements. Each element comprises a key value pair. For example, data object A includes three elements. The three elements in Object A have the following key-value pairs: “size”: “32 kb”, “source”: “user212”, and “format”: “webm”. In some example embodiments, the data objects are stored in a JavaScript Object Notation (JSON) format.

In some example embodiments, the server system (e.g., server system 120 in FIG. 1) receives (704) an update to one or more data objects stored in the database. In some example embodiments, the update is received from a client system (e.g., system 102 in FIG. 1).

In some example embodiments, for each respective object in the one or more data objects (706), the server system (e.g., server system 120 in FIG. 1) determines (708) one or more differences between the original data object and the updated data object. For example, the server system (e.g., server system 120 in FIG. 1) compares the list of elements in the original data object to the list of elements in the updated data object. The server system (e.g., server system 120 in FIG. 1) further compares the values associated with each key to determine whether any of the values have changed.

In some example embodiments, the server system (e.g., server system 120 in FIG. 1) creates (710) a change entry for the respective data object, wherein a change entry includes a textual representation of the one or more differences determined between the original data object and the updated data object and a time stamp 408 associated with the update. In some example embodiments, the textual representation of the change entry is stored as plain text. In some example embodiments, each change entry is stored as a string.

In some example embodiments, the server system (e.g., server system 120 in FIG. 1) stores (712) the created change entry in a change database at the server system 120.

In some example embodiments, the server system (e.g., server system 120 in FIG. 1) receives (714), from a client system (e.g., system 102 in FIG. 1), a data query, wherein the received data query concerns a past state of one or more data objects stored in the database associated with the server system 120.

In some example embodiments, wherein the received search query indicates a particular time for which data about an object is requested. For example, the query requests the value of an element at 11:59 PM on Jan. 1, 1998. In other example embodiments, the received search query indicates a particular value of an element of a data object and requests the date that that element had that particular value. For example, the query requests the time stamp for the first (or last) time that Element A of Object B had the value 17.

For example, the server system (e.g., server system 120 in FIG. 1) receives a query that requests the date that a given element was last changed.

In some example embodiments, the server system (e.g., server system 120 in FIG. 1) converts the received search query into a format to efficiently search the textual representations of the update entries. In some example embodiments, the format used to efficiently search the textual representations of the updates entries uses regular expressions. Regular expressions are a form of pattern matching that use a sequence of characters (e.g., numbers, letters, and symbols) to form a search pattern that can be then matched against text data. Using efficient search techniques such as regular expressions, the search of update entries can be searched more quickly than searching through a database that uses objects or relations.

In some example embodiments, the server system (e.g., server system 120 in FIG. 1) searches (716) one or more change entries stored in the change database to identify the information requested by the received search query. In some example embodiments, searching one or more change entries stored in the change database to identify the information requested by the received search query does not include using the change entries to reconstruct the data set for a given state.

In some example embodiments, searching one or more change entries stored in the change database to identify the information associated with the received search query, further includes, the server system (e.g., server system 120 in FIG. 1) identifying a specific update entry based on the received search query. For example, the search query requests the date when Object A was added to the object database. The server system (e.g., server system 120 in FIG. 1) searches for the specific update that represents the addition of Object A to the object database.

Once the server system (e.g., server system 120 in FIG. 1) has identified an update entry, the server system (e.g., server system 120 in FIG. 1) uses the identified update entry to reconstruct the data object associated with the identified update entry. In some example embodiments, reconstructing a data object (or data state) for a given time involves using known schema to quickly reconstruct the data object.

In some example embodiments, reconstructing a data object includes the server system (e.g., server system 120 in FIG. 1) identifying data associated with an original data object. In some example embodiments, the data from the original data object will be stored in object form (e.g., as a table in a relational database). In some example embodiments, the server system (e.g., server system 120 in FIG. 1) then identifies data associated with an updated data object.

In some example embodiments, the server system (e.g., server system 120 in FIG. 1) identifies difference data describing the differences between the original data object and the updated data object. For example, an update entry lists data from the original object, the updated object, and the difference data. In other example embodiments, the update entry lists only the original object and the difference data and the updated object data can be extrapolated. In other example embodiments, the update entry includes only the update object data and the difference data and the original data object can be extrapolated.

In some example embodiments, the server system (e.g., server system 120 in FIG. 1) selects information associated with the received search query based on the reconstructed data object. For example, if the query seeks to determine the value of associated with a particular element of Object B at time C, the server system (e.g., server system 120 in FIG. 1) reconstructs Object B at time C using only the data in an update entry. Once Object B has been reconstructed, the server system (e.g., server system 120 in FIG. 1) can determine the value of the particular element at the given time.

In some example embodiments, the server system (e.g., server system 120 in FIG. 1) sends (718) the identified information to the client system (e.g., system 102 in FIG. 1).

### Software Architecture

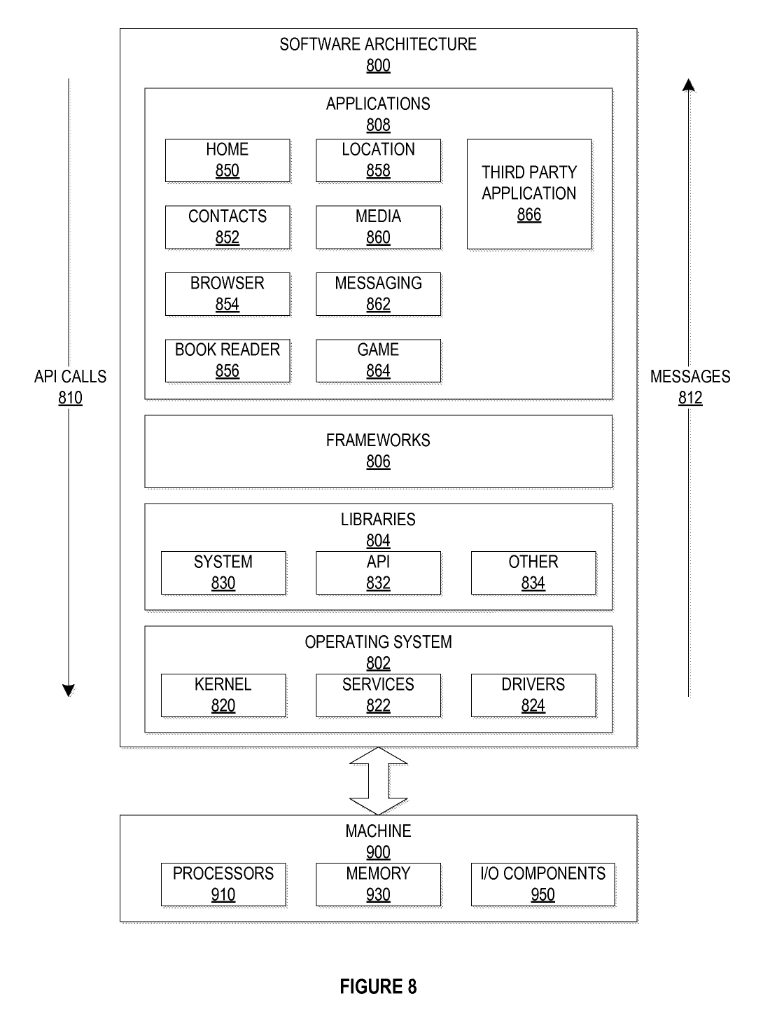

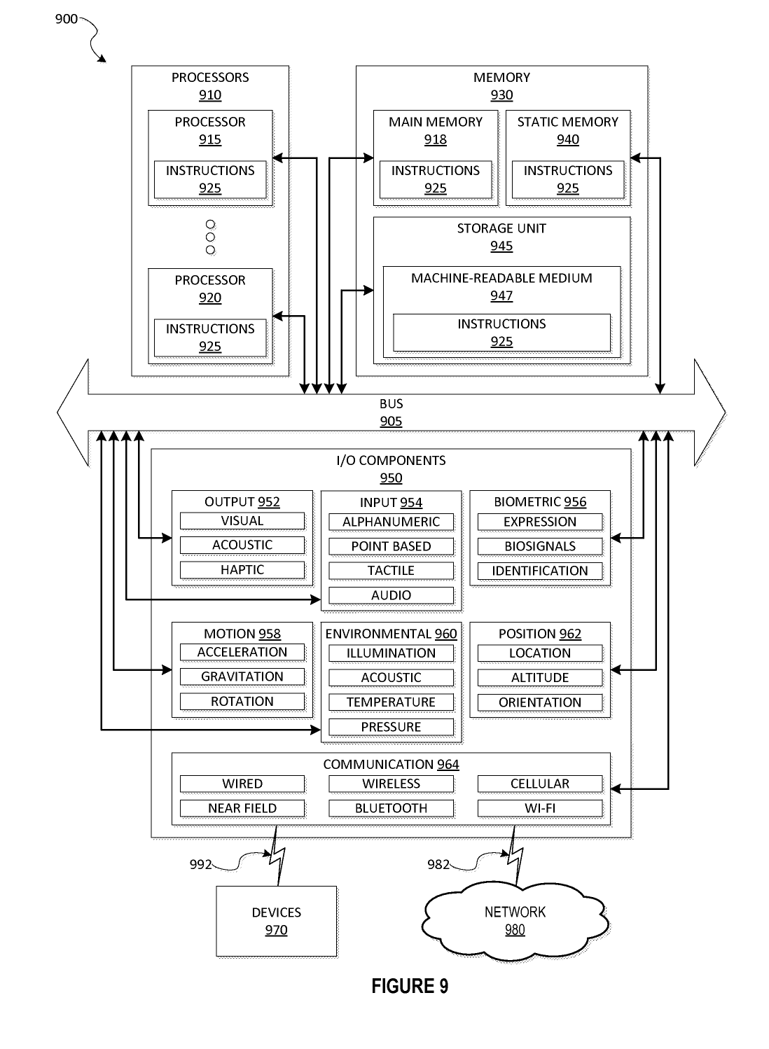

FIG. 8 is a block diagram illustrating an architecture of software 800, in accordance with an example embodiment, which may be installed on any one or more of the devices of FIG. 1 (e.g., the server system 120). FIG. 8 is merely a non-limiting example of a software architecture and it will be appreciated that many other architectures may be implemented to facilitate the functionality described herein. The software 800 may be executing on hardware such as a machine 900 of FIG. 9 that includes processors 910, memory 930, and I/O components 950. In the example architecture of FIG. 8, the software 800 may be conceptualized as a stack of layers where each layer may provide particular functionality. For example, the software 800 may include layers such as an operating system 802, libraries 804, frameworks 806, and applications 808. Operationally, the applications 808 may invoke application programming interface (API) calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 808. The libraries 804 may include system libraries (e.g., C standard library) 830 that may provide functions such as memory allocation functions, string manipulation functions, mathematic functions, and the like. In addition, the libraries 804 may include API libraries 832 such as media libraries (e.g., libraries to support presentation and manipulation of various media formats, such as MPEG4, H.264, MP3, AAC, AMR, JPG, or PNG), graphics libraries (e.g., an OpenGL framework that may be used to render 2D and 3D in a graphic content on a display 206), database libraries (e.g., SQLite that may provide various relational database functions), web libraries (e.g., WebKit that may provide web browsing functionality), and the like. The libraries 804 may also include a wide variety of other libraries 834 to provide many other APIs to the applications 808.

The frameworks 806 may provide a high-level common infrastructure that may be utilized by the applications 808. For example, the frameworks 806 may provide various graphic user interface (GUI) functions, high-level resource management, high-level location services, and so forth. The frameworks 806 may provide a broad spectrum of other APIs that may be utilized by the applications 808, some of which may be specific to a particular operating system 802 or platform.

The applications 808 include a home application 850, a contacts application 852, a browser application 854, a book reader application 856, a location application 858, a media application 860, a messaging application 862, a game application 864, and a broad assortment of other applications, such as a third party application 866. In a specific example, the third party application 866 (e.g., an application developed using the Android™ or iOS™ software development kit (SDK) by an entity other than the vendor of the particular platform) may be mobile software running on a mobile operating system such as iOS™, Android™ Windows® Phone, or other mobile operating systems. In this example, the third party application 866 may invoke the API calls 810 provided by the operating system 802 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 925 (e.g., software, a program, an application, an applet, an app, or other executable code for causing the machine 900 to perform any one or more of the methodologies discussed herein) may be executed. In alternative embodiments, the machine 900 operates as a stand-alone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 900 capable of executing the instructions 925, sequentially or otherwise, that specify actions to be taken by the machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 915 and a processor 920 that may execute instructions 925. The term “processor” is intended to include multi-core processors 910 that may comprise two or more independent processors 915, 920 (also referred to as “cores”) that may execute instructions 925 contemporaneously. Although FIG. 9 shows multiple processors 915, 920, the machine 900 may include a single processor 910 with a single core, a single processor 910 with multiple cores (e.g., a multi-core processor), multiple processors 910 with a single core, multiple processors 910 with multiples cores, or any combination thereof.

The memory 930 may include a main memory 918, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 918, within the static memory 940, within at least one of the processors 910 (e.g., within the processor's cache memory), or any suitable combination thereof, during execution thereof by the machine 900. Accordingly, the main memory 918, the static memory 940, and the processors 910 may be considered machine-readable media 947.

As used herein, the term “memory” refers to a machine-readable medium 947 able to store data temporarily or permanently, and may be taken to include, but not be limited to, random-access memory (RAM), read-only memory (ROM), buffer memory, flash memory, and cache memory. While the machine-readable medium 947 is shown in, an example embodiment, to be a single medium, the term “machine-readable medium” should be taken to include a single medium or multiple media (e.g., a centralized or distributed database, or associated caches and servers) able to store instructions 925. The term “machine-readable medium” shall also be taken to include any medium, or combination of multiple media, that is capable of storing instructions (e.g., the instructions 925) for execution by a machine (e.g., the machine 900), such that the instructions 925, when executed by one or more processors of the machine (e.g., the processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display 206 such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or another pointing instrument), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 962 may include location sensor components (e.g., a Global Position System (GPS) receiver component), altitude sensor components (e.g., altimeters and/or barometers that detect air pressure, from which altitude may be derived), orientation sensor components (e.g., magnetometers), and the like.

Communication may be implemented using a wide variety of technologies. The I/O components 950 may include communication components 964 operable to couple the machine 900 to a network 980 and/or to devices 970 via a coupling 982 and a coupling 992 respectively. For example, the communication components 964 may include a network interface component or another suitable device to interface with the network 980. In further examples, communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine 900 and/or any of a wide variety of peripheral devices (e.g., a peripheral device coupled via a Universal Serial Bus (USB)).

Moreover, the communication components 964 may detect identifiers and/or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 964, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 925 may be transmitted and/or received using a transmission medium via the coupling 992 (e.g., a peer-to-peer coupling) to the devices 970. The term “transmission medium” shall be taken to include any intangible medium that is capable of storing, encoding, or carrying the instructions 925 for execution by the machine 900, and includes digital or analog communications signals or other intangible media to facilitate communication of such software.

Furthermore, the machine-readable medium 947 is non-transitory (in other words, not having any transitory signals) in that it does not embody a propagating signal. However, labeling the machine-readable medium 947 “non-transitory” should not be construed to mean that the medium is incapable of movement; the medium should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been described with reference to specific embodiments. However, the illustrative discussions above are not intended to be exhaustive or to limit the possible embodiments to the precise forms disclosed. Many modifications and variations are possible in view of the above teachings. The embodiments were chosen and described in order to best explain the principles involved and their practical applications, to thereby enable others skilled in the art to best utilize the various embodiments with various modifications as are suited to the particular use contemplated.

It will also be understood that, although the terms “first,” “second,” etc. may be used herein to describe various elements, these elements should not be limited by these terms. These terms are only used to distinguish one element from another. For example, a “first contact” could be termed a “second contact,” and, similarly, a “second contact” could be termed a “first contact,” without departing from the scope of the present embodiments. The first contact and the second contact are both contacts, but they are not the same contact.

The terminology used in the description of the embodiments herein is for the purpose of describing particular embodiments only and is not intended to be limiting. As used in the description of the embodiments and the appended claims, the singular forms “a,” “an,” and “the” are intended to include the plural forms as well, unless the context clearly indicates otherwise. It will also be understood that the term “and/or”, as used herein, refers to and encompasses any and all possible combinations of one or more of the associated listed items. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining (the stated condition or event)” or “in response to determining (the stated condition or event)” or “upon detecting (the stated condition or event)” or “in response to detecting (the stated condition or event),” depending on the context.

This written description uses examples to enable any person skilled in the art to practice the inventive subject matter, including making and using any devices 970 or systems and performing any incorporated methods. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
storing one or more data objects in a database associated with a server system;
receiving, at the server system, an update to one or more data objects stored in the database;
for a respective object of the one or more data objects:
determining one or more differences between the respective original data object and the respective updated data object;
creating a change entry for the respective data object, wherein a change entry includes a textual representation of the one or more differences determined between the original data object and the updated data object and a time stamp associated with the update;
storing the created change entry in a change database at the server system;
receiving, from a client system, a data query, wherein the received data query concerns a past state of one or more data objects stored in the database associated with the server system;
searching one or more change entries stored in the change database to identify the information associated with the received search query, and
sending the identified information to the client system.

2. The method of claim 1, wherein each data object comprises one or more elements.

3. The method of claim 2, wherein each element comprises a key value pair.

4. The method of claim 1, wherein the textual representation of the change entry is as plain text.

5. The method of claim 1, wherein the data objects are stored in a JavaScript Object Notation format.

6. The method of claim 1, wherein each change entry is stored as a string.

7. The method of claim 1, wherein searching one or more change entries stored in the change database to identify the information requested by the received search query does not include using the change entries to reconstruct the data set for a given state.

8. The method of claim 1, wherein before searching one or more change entries stored in the change database to identify the information associated with the received search query, converting the received search query into a format to efficiently search the textual representations of the update entries.

9. The method of claim 8, wherein the format used to efficiently search the textual representations of the updates entries uses regular expressions.

10. The method of claim 1, wherein searching one or more change entries stored in the change database to identify the information associated with the received search query, further includes:
identifying a specific update entry based on the received search query;
using the identified update entry to reconstruct the data object associated with the identified update entry; and
selecting information associated with the received search query based on the reconstructed data object.

11. The method of claim 10, wherein using the identified update entry to reconstruct the data object associated with the identified entry agent further includes:
identifying data associated with an original data object;
identifying data associated with an updated data object; and
identifying difference data describing the differences between the original data object and the updated data object.

12. The method of claim 1, wherein the received search query indicates a particular time.

13. The method of claim 1, wherein the received search query indicates a particular value of an element of a data object.

14. The method of claim 10, further comprising using known schema to reconstruct the data object associated with the identified entry agent.

15. A server system comprising:
a storage module to store one or more data objects in a database associated with a server system;
a reception module to receive, at the server system, an update to one or more data objects stored in the database;
an update logging module implemented by one or more processors to, for a respective object of the one or more data objects:
determine one or more differences between the respective original data object and the respective updated data object;
create a change entry for the respective data object, wherein a change entry includes a textual representation of the one or more differences determined between the original data object and the updated data object and a time stamp associated with the update; and
store the created change entry in a change database at the server system;
a query service module to receive, from a client system, a data query, wherein the received data query concerns a past state of one or more data objects stored in the database associated with the server system;
a search module, implemented by one or more of the processors to search one or more change entries stored in the change database to identify the information associated with the received search query, and
a transmission module to send the identified information to the client system.

16. The system of claim 15, wherein each data object comprises one or more elements.

17. The system of claim 16, wherein each element comprises a key value pair.

18. A non-transitory computer-readable storage medium storing instructions that, when executed by the one or more processors of a machine, cause the machine to perform operations comprising:
storing one or more data objects in a database associated with a server system;
receiving, at the server system, an update to one or more data objects stored in the database;
for a respective object of the one or more data objects:
determining one or more differences between the respective original data object and the respective updated data object;
creating a change entry for the respective data object, wherein a change entry includes a textual representation of the one or more differences determined between the original data object and the updated data object and a time stamp associated with the update;
storing the created change entry in a change database at the server system;
receiving, from a client system, a data query, wherein the received data query concerns a past state of one or more data objects stored in the database associated with the server system;
searching one or more change entries stored in the change database to identify the information associated with the received search query, and
sending the identified information to the client system.

19. The non-transitory computer-readable storage medium of claim 18, wherein each data object comprises one or more elements.

20. The non-transitory computer-readable storage medium of claim 19, wherein each element comprises a key value pair.
